(19) United States
(12) Patent Application Publication
(10) Pub. No.: US 2021/0291939 A1
(43) Pub. Date: Sep. 23, 2021

(54) UNDERWATER MATERIAL PLACEMENT AND RELEASE SYSTEM

(71) Applicant: CASHMAN DREDGING AND MARINE CONTRACTING, CO., LLC, Quincy, MA (US)

(72) Inventors: Richard Robinson, Argyle, NY (US); Jay Cashman, Quincy, MA (US)

(21) Appl. No.: 17/205,701

(22) Filed: Mar. 18, 2021

Related U.S. Application Data
(60) Provisional application No. 62/991,478, filed on Mar. 18, 2020.

(51) Int. Cl. B63B 27/16; B63B 35/00; G05D 1/00; G01S 19/42

(52) U.S. Cl. CPC B63B 27/16; B63B 35/00; G01S 19/42; G05D 1/0094; G05D 1/0011

(57) ABSTRACT

A system for underwater material placement and release is provided that includes a frame and a plurality of quick release couplings. The quick release couplings can depend from the frame in a two dimensional array. The plurality of quick release couplings can be configured to be releasably coupled to a concrete mat and remotely released therefrom via a control system. A method for placing concrete mats includes provision of the system having a frame and a plurality of quick release couplings. A lifting device can be provided. The system can be connected to the lifting device. A concrete mat can be connected to the quick release couplings of the system. The frame can be lowered to a predetermined depth where the concrete mat is adjacent to a floor of a body of water. The concrete mat can be released from the quick release couplings.

### CROSS-REFERENCE TO RELATED APPLICATIONS

This application claims the benefit of U.S. Provisional Application Ser. No. 62/991,478 filed on Mar. 18, 2020. The entire disclosure of the above application is incorporated herein by reference.

### FIELD

The present disclosure relates to positioning and placement of underwater materials, and more particularly, a system for positioning and placement of concrete mats.

### INTRODUCTION

This section provides background information related to the present disclosure which is not necessarily prior art.

Beach and other shoreline erosion, especially in coastal areas, is a major concern to property owners who have residences or establishments that are situated in close proximity to the shoreline. Not only is there a tremendous personal and economic loss caused by damage to, or loss of, real estate, housing and commercial buildings by shoreline or beach erosion, but there is also recreational loss of waterfront property which adversely affects the general public. To deter coastal erosion in many areas, large seawalls are constructed to prevent high tides from reaching land and property. Such structures are costly and are only practical when population densities make it economically reasonable to construct them. Further, such structures have an adverse effect on the natural appearance of the shoreline and, in many areas, cannot be practically constructed.

Other methods of shoreline protection and/or reclamation include creating jetties or artificial barriers or reefs that extend from the shoreline. These structures are permanent installations and are generally utilized to prevent sand along coastal areas from washing out to sea or filling in inlets and the like by wave action. Like seawalls, however, such structures are costly to construct and maintain and, in some areas, are not appropriate for use due to the shoreline configuration, prevailing currents, tidal activity, and the like. Also, such structures create a safety hazard in areas where recreational activity is anticipated.

A further method for reclaiming shoreline areas and preventing erosion is the placement of offshore, underwater barriers. Often, large porous structures are placed along a sea floor or riverbed at some distance from the existing shoreline. The structures are provided to break waves, currents, or tidal action, thereby creating a zone of low velocity water flow adjacent a beach or riverbank so that sand, silt, and other particulate material will settle out of the water before being conveyed by fluid currents out from the shoreline. Again, such outer barriers are only appropriately used in some locations and are not appropriate for use in many locations and can be objectionable for use in some areas due to an adverse effect on aquatic life.

Articulated Concrete Blocks (ACBs) can also be utilized to prevent shoreline erosion. ACBs provide a hard, armorlike surface that can be used as an alternative to concrete or other permanent erosion control systems. Examples of ACBs include mats that are made of a matrix of individual concrete blocks placed together to form an erosion-resistant overlay. The flexible, interlocking matrix of concrete blocks of uniform size, shape, and weight is connected by a series of cables which pass longitudinally through preformed ducts in each block.

ACB mats are flexible and are able to mold to an existing area. This is especially beneficial in the event that the ground underneath the mat were to shift, as the cables would hold the blocks in place while allowing slight movement versus the cracking that would occur in a slab of concrete. In addition, the blocks can be infilled with stone or soil allowing vegetation growth therein. Typical applications include (but are not limited to) channels, shoreline restoration, and boat ramps. However, placement of ACB mats can be cumbersome and dangerous. Often, the process requires multiple divers to ensure proper placement of the ACB mats.

There is a continuing need for a system and method to increase workforce safety and to increase productivity in the placement of articulated concrete mats on environmental remediation projects and coastal defense projects.

### SUMMARY

In concordance with the instant disclosure, ways to increase workforce safety and to increase productivity in the placement of articulated concrete mats on environmental remediation projects and coastal defense projects, have been surprisingly discovered.

In certain embodiments, a system for underwater material placement and release is provided that includes a frame and a plurality of quick release couplings. The quick release couplings can depend from the frame in a two dimensional array. The plurality of quick release couplings can be configured to be releasably coupled to a concrete mat and remotely released therefrom via a control system.

In certain embodiments, a method for placing concrete mats includes provision of a system having a frame and a plurality of quick release couplings. The quick release couplings can depend from the frame in a two dimensional array. The plurality of quick release couplings can be configured to be releasably coupled to a concrete mat and remotely released therefrom via a control system. A lifting device can be provided. The system can be connected to the lifting device. A concrete mat can be connected to the quick release couplings of the system. The frame can be lowered to a predetermined depth where the concrete mat is adjacent to a floor of a body of water. The concrete mat can be released from the quick release couplings.

The present technology provides systems that can be coupled to a crane or hoisting device for the purpose of lifting, swinging into place, positioning, and remotely unhooking a load placed in a desired underwater position. The system can include a combination of a frame for lifting a given load and a quick release coupling, including one or more pneumatic hooks, for example, that release underwater in response to a remote signal. The lifting frame can hold a carriage for compressed air tanks and electronic components for receiving an operator's commands, including the remote signal for controlling the quick release coupling open/close mechanism.

The present systems provide several advantages when compared to other ways of placing materials underwater. The system can increase workforce safety and productivity by requiring fewer workers and divers. In fact, work required by divers can be drastically reduced and potentially eliminated in some scenarios. The system can greatly reduce the labor and cost of the process of laying the ACB mats. While this system and method can be primarily used in near shore shallow waters, other uses are also contemplated within the scope of this disclosure.

The system can be especially configured to lower concrete mats into position underwater and to release the underwater mats without the need for manual intervention by divers at the site. Although the system is described and shown herein being used with concrete mats, it should be appreciated that the system can be used for placement and release of any other type of underwater material, as desired.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top perspective view of a system for underwater material placement and release, according to one embodiment of the present disclosure;

FIG. 2 is a side elevational view of the system for underwater material placement and release shown in FIG. 1, further depicting a concrete mat being placed on a flat floor of a body of water;

FIG. 3 is a side elevational view of the system for underwater material placement and release shown in FIG. 1, further depicting the concrete mat being placed on an inclined floor of the body of water;

FIG. 4 is a side elevational view of the system for underwater material placement and release shown in FIG. 1, further depicting a lifting device connected to the frame for placing the concrete mat on the flat floor of the body of water; and

FIG. 5 is a flow chart illustrating a method, according to another embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as can be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items can be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that can arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments can alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that can be recited in the art, even though element D is not explicitly described as being excluded herein.

When an element or layer is referred to as being “on,” “engaged to,” “connected to,” or “coupled to” another element or layer, it can be directly on, engaged, connected, or coupled to the other element or layer, or intervening elements or layers can be present. In contrast, when an element is referred to as being “directly on,” “directly engaged to,” “directly connected to” or “directly coupled to” another element or layer, there can be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. can be used herein to describe various elements, components, regions, layers and/or sections, these elements, components, regions, layers and/or sections should not be limited by these terms. These terms can be only used to distinguish one element, component, region, layer, or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, can be used herein for ease of description to describe one element or feature's relationship to another element(s) or feature(s) as illustrated in the figures. Spatially relative terms can be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

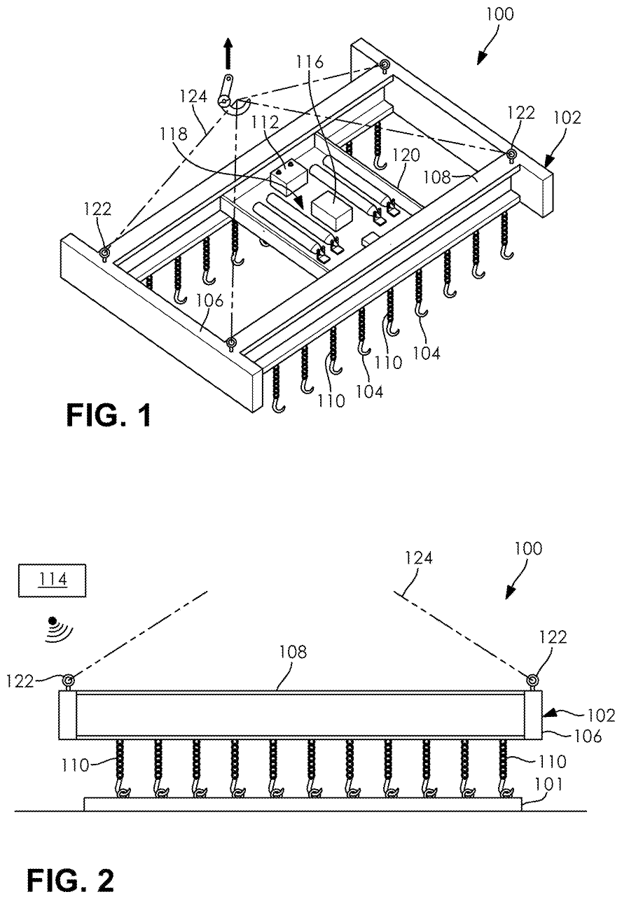

As shown in FIGS. 1-4, a system 100 for underwater material placement and release is shown. It should be appreciated that the system 100 can be configured to lower a concrete mat 101 into position underwater and to release the concrete mat 101 without a need for manual intervention by divers at the site.

Although the system 100 is described and shown herein being used with concrete mats 101, it should be appreciated that the system 100 can be used for placement and release of any other type of material underwater, as desired. As non-limiting examples, one system 100 can be configured, as described hereinbelow, for multiple end uses, including but not limited to, underwater placement of construction materials, including concrete block(s), rock armor used in shoreline protection, pipe(s), as well as for supplying materials to divers underwater. It should be appreciated that the concrete mat 101 can be an articulated concrete block mat that can include a matrix of individual concrete blocks placed together to form an erosion-resistant overlay.

The system 100 can include a frame 102 and one or more quick release couplings 104. The quick release couplings 104 can be connected to the frame 102. In certain examples the frame 102 can be substantially planar. The quick release couplings 104 can be arranged on the frame 102 in a two dimensional array. The two dimensional array of the quick release couplings 104 can include an array, in which the quick release couplings 104 are disposed multiaxially on a planar surface of the frame 102. Advantageously, the two dimensional array can be well suited to lift and place substantially planar concrete mats 101, where the mat has a length and a width that are substantially greater than a thickness of the concrete mat 101.

In particular examples, the quick release couplings 104 can include hooks. The frame 102 can be attached to a lifting device 103. The lifting device 103 can be a crane, as a non-limited example. The quick release couplings 104 can be reversibly attached to the concrete mat 101. The lifting device 103 can be used to lower the frame 102 into a body of water with the concrete mat 101 coupled thereto, where the concrete mat 101 can be disposed underwater.

The frame 102 can include two side supports 106. One or more cross beams 108 can be disposed between each of the two side supports 106. Each of the cross beams 108 can extend from one side support 106 to another side support 106. In particular, one of the side supports 106 can be disposed parallel to the other side support 106 and each one of the cross beams 108 can be disposed substantially perpendicular to each of the side supports 106. Each of the cross beams 108 can be spaced apart from an end of the side supports 106. In other words, each of the side supports 106 can extend past where the ends of the cross beams 108 are joined or coupled thereto, as shown in FIG. 1. Accordingly, the side supports 106 and the cross beams 108 of the frame 102 can define an I-shape of the frame 102, as one non-limiting example. A skilled artisan can arrange the frame 102 in other suitable configurations, as desired.

While FIG. 1 depicts the frame 102 having two cross beams 108, it should be appreciated that the frame 102 can include more than two cross beams 108, as needed. In particular, dimensions of the concrete mat 101 can determine the approximate number of cross beams 108 required to effectively place the concrete mat 101. For example, a relatively longer concrete mat 101 can require additional cross beams 108, whereas a relatively shorter concrete mat 101 can require fewer cross beams 108.

The frame 102 can be formed by a single unitary piece, such that the cross beams 108 can be irremovably affixed to the side supports 106. For example, the cross beams 108 can be welded to the side supports 106. In other embodiments, the cross beams 108 can be removably secured to the side supports 106 via mechanical fasteners. For example, the fasteners can include bolts or screws. A skilled artisan can select other suitable methods of securing the cross beams 108 to the side supports 106, as desired.

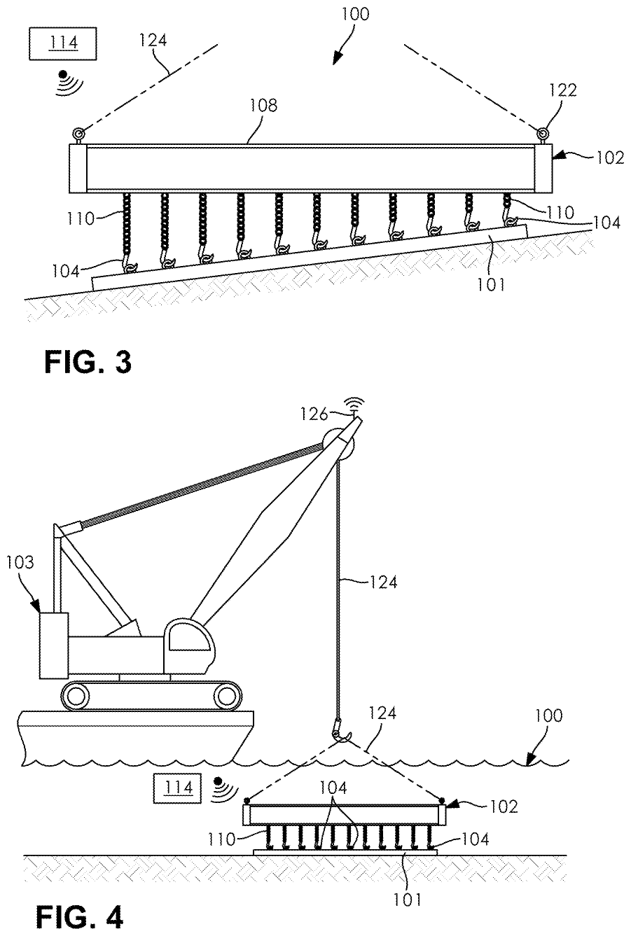

With continued reference to FIGS. 1-3, one or more quick release couplings 104 can be attached to the cross beams 108. In certain embodiments, each one of the quick release couplings 104 can be attached to one of the cross beams 108 with a chain 110. The chains 110 can be configured to space the quick release couplings 104 apart from the cross beams 108, in operation. A length of the chains 110 can be adjusted as needed for each project. For example, as shown in FIG. 2, each of the chains 110 has substantially the same length where the floor of the body of water is substantially level. As shown in FIG. 3, some of the chains 110 have a greater length than other chains 110 where the floor of the body of water is inclined. Advantageously, the chains 110 can allow concrete mats 101 to be disposed at an incline while allowing the frame 102 to remain substantially level, in operation.

The quick release coupling 104 can be selectively released, as desired, to place the concrete mat 101. In a particular non-limiting example, a pneumatic system 118 can be used to actuate the quick release coupling 104. Accordingly, the quick release coupling 104 can be actuated or otherwise decoupled from the concrete mat through the use of compressed gas. A solenoid valve (not shown) of the pneumatic system 118 can be used to selectively actuate the quick release coupling 104. For example, the hooks can secured to the concrete mat 101, and when the concrete mat 101 is placed on the floor of the body of water, the valve can be actuated, which can open the quick release couplings 104. One particular type of pneumatic system 118 is shown and described in U.S. Pat. No. 4,416,480 to Moody, the entire disclosure of which is incorporated herein by reference. Other quick release couplings 104 can be utilized within the system 100, such as those that are commercially available from SAUR having offices in Panambi, Rio Grande do Sul, Brazil. A skilled artisan can select other suitable quick release couplings, within the scope of the present disclosure.

The system 100 can further include a control system. The control system allows certain aspects of the system 100 to be remotely controlled, thereby, reducing the need for underwater divers during placement of the concrete mats 101, as described in greater detail hereinbelow. The control system can include a frame controller 112 and a remote controller 114. The remote controller 114 can be in wireless communication with the frame controller 112 or can be directly wired to communicate with the frame controller 112.

Each of the frame controller 112 and the remote controller 114 can have a processor and memory. The memory can include a tangible, non-transitory computer readable medium with processor-excitable instructions stored thereon. In certain examples, each of the frame controller 112 and the remote controller 114 can transmit a signal to a software platform having a graphical user interface (GUI). Desirably, this can permit a user to view and input instructions to each of the frame controller 112 and the remote controller 114 via the GUI of the software platform.

Each of the frame controller 112 and the remote controller 114 can be in communication with a wireless transceiver 116. The wireless transceiver 116 can allow wireless signals to be sent between the frame controller 112 and the remote controller 114. Advantageously, the wireless communication between the frame controller 112 and the remote controller 114 allows for off-site control of the quick release couplings 104. For example, the user can input instructions to the remote controller 114, which in turn, can wirelessly send a signal to the frame controller 112. The frame controller 112 can signal the solenoid valve to pneumatically open each of the quick release couplings 104, thereby, releasing the concrete mat 101.

It should be appreciated that the control system can be configured to control the lifting device 103, in certain embodiments. The remote controller 114 can send a signal to the lifting device 103 to lower the frame 102 to a predetermined depth above the floor of the body of water. The remote controller 114 can likewise signal the lifting device 103 to raise the frame 102 out of the water after the quick release couplings 104 have been actuated and decoupled from the concrete mat 101.

The system 100 can further include a global positioning system (GPS) unit 126. The GPS unit 126 can be in communication with each of the frame controller 112 and the remote controller 114. The GPS unit 126 can be configured to monitor a placement of the concrete mat 101. In certain examples, the GPS unit can be disposed on the lifting device 103. Advantageously, the GPS unit can be configured to allow for an accurate placement of the concrete mat 101. Accordingly, the GPS unit 126 can be configured to send a signal to the control system with real time position data for the frame 102. The GPS unit 126 can also send a signal to the control system when the frame 102 is accurately placed above a predetermined location on the floor of the body of water. The GPS unit 126 can likewise signal the control system if the frame 102 is inaccurately placed, and allow for adjustments to the position of the frame by the operator.

A utility tray 120 can be disposed on the frame 102. The utility tray 120 can be disposed between the cross beams 108. The frame controller 112 can be disposed in the utility tray 120. Gas tanks containing the pressurized gas to actuate the quick release coupling 104 can be disposed in the utility tray 120. As one non-limiting example, the gas can be compressed nitrogen gas. Additionally, waterproof batteries configured to power the frame controller 112 and the solenoid valve of the pneumatic system 118 for the quick release coupling 104 can be disposed in the utility tray 120.

The frame 102 can further include line connectors 122. The line connectors 122 can be metal eyelets, as one non-limiting example. The line connectors 122 can be configured to receive a line 124. The line can be configured to connect the frame 102 to the lifting device 103. The line connectors 122 can be disposed at each of the corners of the frame 102. Advantageously, this arrangement of line connectors 122 can provide stability to the system 100 to enable the frame 102 to be lowered while maintaining the parallel orientation with the floor of the body of water. More than one line 124 can be utilized, as needed.

The line 124 can be fabricated from a durable material. The durable material can be submerged in fresh or salt water for extended periods of time without damaging the line 124. The line 124 can be one of a wire, a rope, and a chain, as non-limiting examples. A skilled artisan can select other suitable materials and configurations for the line 124, as desired.

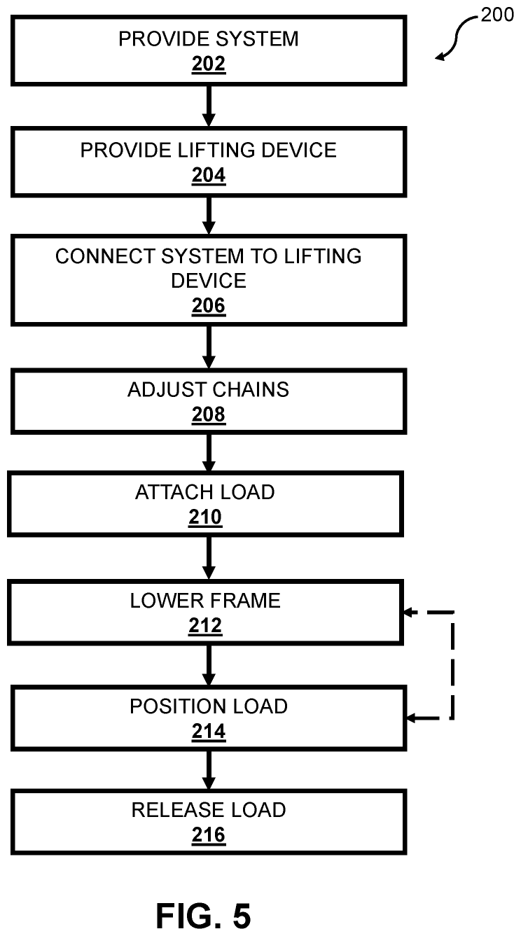

With reference to FIG. 5, the present disclosure further contemplates a method 200 for placing a load, for example, a concrete mat 101. The method can have a step 202 of providing the system 100 as described herein above. The method 200 can have a step 204 of providing the lifting device 103, such as a crane. It should be appreciated that the lifting device 103 of the present disclosure can be located on a shore adjacent to the body of water. Advantageously, the system 100 can therefore be utilized to place the concrete mat 101 in relatively shallow waters.

A step 206 can include connecting the system 100 to the lifting device 103. In particular the line 124 can be run through the line connectors 122 of the frame 102 and connected to the lifting device 103.

A step 208 of the method 200 can include adjusting the chains 110, as needed. In particular, topographic details of the floor of the body of water to receive the concrete mat 101 can determine what adjustments must be made. When the floor is level, the chains 110 can all have substantially the same length. When the floor has an incline, the lengths of the chains 110 can be adjusted such that the concrete mat 101 is disposed on the chains 110 at the same angle as the incline of the floor, for example, as shown in FIG. 3.

A step 210 can include attaching a concrete mat 101 to the quick release coupling 104 of the system 100. The quick release coupling 104 can be in the open position to receive the concrete mat 101. The quick release coupling 104 can then be secured in the closed position during transport of the concrete mat 101.

A step 212 of the method 200 can include lowering the frame 102 to a predetermined depth where the concrete mat 101 is adjacent to a floor of a body of water. The lifting device 103 can transport the concrete mat 101 from a shoreline to a position above the floor to receive the concrete mat 101. The frame 102 can be submerged in the water and lowered until the concrete mat 101 is adjacent to the floor.

A step 214 of the method 200 can include positioning the load or concrete mat 101. The step 214 can be performed concurrently with the step 212. The GPS unit 126 of the lifting device 103 can monitor the position of the concrete mat 101, while it is lowered. The GPS unit 126 can signal to the control system if it detects the frame 102 is not in line with the predetermined location on the floor of the body of water. The position of the frame 102 can be adjusted, as necessary, based on the position data from the GPS unit 126.

A step 216 of the method 200 can include releasing the concrete mat 101 from the quick release couplings 104. In particular, the operator can instruct the remote controller 114 to signal the release of the concrete mat 101. The remote controller 114 can then signal the frame controller 112. The frame controller 112 can actuate the valve of the pneumatic system 118 to actuate the quick release coupling 104, thereby opening the quick release coupling 104. When the quick release couplings 104 are opened, the concrete mat 101 can be released into position on the seafloor.

It should be appreciated that the system 100 is especially configured to lower one or more concrete mats 101 into position underwater and to release the mats 101 underwater without the need for manual intervention by divers at the site. There are several advantages to the system 100 of the present disclosure. The system 100 can increase workforce safety and productivity by requiring fewer workers and divers. In fact, work required by divers can be drastically reduced and potentially eliminated in some scenarios. The system 100 can greatly reduce the labor and cost of the process of laying ACB mats.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments can be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. A system for underwater material placement and release, comprising:
a frame; and
a plurality of quick release couplings depending from the frame in a two dimensional array, the plurality of quick release couplings configured to be releasably coupled to a concrete mat and remotely released therefrom via a control system.

2. The system of claim 1, wherein the frame is substantially planar.

3. The system of claim 1, wherein each of the quick release couplings is in communication with a pneumatic system configured to release the quick release couplings.

4. The system of claim 3, wherein the control system is in wireless communication with and configured to actuate the pneumatic system to release the quick release couplings.

5. The system of claim 1, wherein the control system includes a frame controller disposed on the frame, the frame controller configured to actuate the quick release couplings.

6. The system of claim 5, wherein the control system includes a remote controller configured to wirelessly signal the frame controller.

7. The system of claim 6, wherein each of the remote controller and the frame controller are in communication with a wireless transceiver.

8. The system of claim 7, wherein the frame includes a utility tray.

9. The system of claim 8, wherein the frame controller is disposed in the utility tray.

10. The system of claim 1, wherein the frame includes two side supports and a plurality of cross beams extending between the two side supports.

11. The system of claim 6, further comprising a global positioning system (GPS) unit in communication with the frame controller and the remote controller.

12. The system of claim 1, wherein the cross beams and the side supports define an I-shape of the frame.

13. The system of claim 1, wherein each one of the quick release couplings is connected to the frame via a chain.

14. The system of claim 13, wherein each chain has a length that is adjustable.

15. A method for placing concrete mats, comprising:
providing a system for underwater material placement and release, including:
a substantially planar frame; and
a plurality of quick release couplings depending from the substantially planar frame in a two dimensional array, the plurality of quick release couplings configured to be releasably coupled to a concrete mat and remotely released therefrom via a control system;
providing a lifting device;
connecting the system to the lifting device;
attaching a concrete mat to the plurality of quick release couplings of the system;
lowering the frame to a predetermined depth where the concrete mat is adjacent to a floor of a body of water; and
releasing the concrete mat from the quick release couplings.

16. The method of claim 15, wherein each one of the quick release couplings is connected to the frame via a chain having an adjustable length.

17. The method of claim 16, further comprising a step of adjusting a length of at least one of the chains before attaching the concrete mat to the plurality of quick release couplings.

18. The method of claim 15, wherein the control system includes a remote controller and a frame controller disposed on the frame, wherein the remote controller is configured to signal the frame controller and the frame controller is configured to release the quick release couplings, thereby, releasing the concrete mat.

19. The method of claim 15, wherein the lifting device is located on a shore adjacent to the body of water.

20. The method of claim 15, wherein the concrete mat includes an articulated concrete block mat.
